(19) United States
(12) Patent Application Publication
(10) Pub. No.: US 2012/0194594 A1
(43) Pub. Date: Aug. 2, 2012

(54) INKJET PRINTING APPARATUS AND INKJET PRINTING METHOD

(75) Inventors: Yasunori Fujimoto, Inagi-shi (JP); Yoshinori Nakajima, Yokohama-shi (JP)

(73) Assignee: CANON KABUSHIKI KAISHA, Tokyo (JP)

(21) Appl. No.: 13/354,904

(22) Filed: Jan. 20, 2012

(30) Foreign Application Priority Data
Jan. 28, 2011 (JP) 2011-016783

(51) Int. Cl. B41J 2/205

(52) U.S. Cl. 347/15

(57) ABSTRACT

There is provided an inkjet printing apparatus which performs a plurality of times of scans by a print head on a predetermined region and completes printing of the predetermined region by ejecting ink from the print head by the plurality of times of the scans, comprising generating means for performing a mask process in use of a mask to binary data of each of pixels constituting an image to be printed on the predetermined region to generate ejection data used in each of the plurality of times of the scans, wherein the mask assigns the binary data showing printing for each pixel to a plurality of times of scans among the plurality of times of the scans completing the printing to generate the ejection data for each scan of the pixel.

### BACKGROUND OF THE INVENTION

1. Field of the Invention

This invention relates to an inkjet printing apparatus and an inkjet printing method for applying ink drops on a print medium to print an image thereon, which enable a predetermined density expression even in use of image data for use in printing by various kinds of binarization methods.

2. Description of the Related Art

In an inkjet printing apparatus, there is known one method for improving an image quality by reducing a granular feeling, which reduces an ink drop ejected from a print head to be small in size. In addition, dots formed by such small ink drops are arranged in a preferable density on the print medium, thus acquiring a desired printing density. In this case, as an ejection quantity ejected from the print head decreases, a density of dots which should be formed for acquiring the desired printing density increases. However, in a case where the density of the dots, that is, the resolution is increased to perform printing with high density, there occurs a problem that the printing speed becomes slow due to a relation with a driving frequency of the print head.

In order to solve this problem, Japanese Patent Laid-Open No. 2005-104086 discloses a technology that the printing is performed in such a manner as to include a pixel on which the ink drop is applied twice in more than some gradation level. Specially, as shown in FIG. 9, a dot arrangement pattern of 2×2 pixels is associated with each of data quantized into five values from level 0 to level 4. For example, in level 3, an ink drop is further applied on one pixel among three pixels on each of which the ink drop is applied one time, and consequently, the ink drop is applied twice on the one pixel. In level 4 also, there are likewise provided pixels on each of which the ink drop is applied twice. Therefore, the printing with a high density can be achieved also in the printing at a relatively low resolution.

### SUMMARY OF THE INVENTION

However, according to Japanese Patent Laid-Open No. 2005-104086, for example, in a case of printing a dot arrangement pattern of 2×2 pixels as shown in FIG. 9, there is used a mask pattern in which an ink drop is applied on each of the upper left and lower right pixels one time and on each of the lower left and upper right pixels twice. In this case, there occurs no problem when the dot arrangement pattern as shown in FIG. 9 is used, but, for example, when the above mask is used to binary data of the other type, there is a possibility that the mask interferes with the binary data to generate moiré in a printing image, deteriorating an image quality.

For example, there are some cases where, due to a demand for use of an independent binarization method (for example, dot technology) from a RIP (Raster Image Processor) bender or the like, there is used an input mode in which binary image data for use in printing is inputted directly into an inkjet printing apparatus. In this case, when the mask in which the number of dots for printing is made to be different depending on the position of the pixel as described above is used as it is, there is a possibility that there occurs the problem with the interference as mentioned above. On the other hand, when printing data in consideration of an influence on the mask is generated for avoiding this problem, a degree of freedom in design of the independent binarization by RIP bender or the like results in being remarkably damaged.

Therefore, an object of the present invention is to provide an inkjet printing apparatus and an inkjet printing method which can directly input binary image data for use in printing without an influence on a density expression of a printing image due to a difference in a binarization method or in a data producer for use.

In order to solve the above problem, an inkjet printing apparatus according to the present invention which performs a plurality of times of scans by a print head on a predetermined region and completes printing of the predetermined region by ejecting ink from the print head by the plurality of times of the scans, comprises:

generating means for performing a mask process in use of a mask to binary data of each of pixels constituting an image to be printed on the predetermined region to generate ejection data used in each of the plurality of times of the scans,

wherein the mask assigns the binary data showing printing for each pixel to a plurality of times of scans among the plurality of times of the scans completing the printing to generate the ejection data for each scan of the pixel.

In order to solve the above problem, an inkjet printing apparatus according to the present invention which performs a plurality of times of scans by a print head on a predetermined region and performs printing by ejecting ink from the print head by the plurality of times of the scans, comprises:

first generating means for performing a mask process in use of a mask to binary data of each of pixels constituting an image to be printed on the predetermined region, which is obtained according to a dot arrangement pattern specified by multi-level data having a gradation level of two or more values, to generate ejection data for a first print mode used in each of the plurality of times of the scans;

second generating means for performing a mask process in use of a mask to the binary data of each of the pixels constituting the image to be printed on the predetermined region to generate ejection data for a second print mode used in each of the plurality of times of the scans; and

control means for changing the ejection data generation by the first generating means or by the second generating means corresponding to a form of the binary data of each of the pixels constituting the image to be printed on the predetermined region,

wherein the mask used in the second generating means assigns the binary data showing printing for each pixel to a plurality of times of scans among the plurality of times of the scans completing the printing to generate the ejection data for each scan of the pixel.

In order to solve the above problem, an inkjet printing method according to the present invention provided with an inkjet printing apparatus which performs a plurality of times of scans by a print head on a predetermined region and completes printing of the predetermined region by ejecting ink from the print head by the plurality of times of the scans, comprises:

a generating step for performing a mask process in use of a mask to binary data of each of pixels constituting an image to be printed on the predetermined region to generate ejection data used in each of the plurality of times of the scans,

wherein the mask assigns the binary data showing printing for each pixel to a plurality of times of scans among the plurality of times of the scans completing the printing to generate the ejection data for each scan of the pixel.

In order to solve the above problem, an inkjet printing method according to the present invention provided with an inkjet printing apparatus which performs a plurality of times of scans by a print head on a predetermined region and performs printing by ejecting ink from the print head by the plurality of times of the scans, comprises:

a first generating step for performing a mask process in use of a mask to binary data of each of pixels constituting an image to be printed on the predetermined region, which are obtained according to a dot arrangement pattern specified by multi-level data having a gradation level of two or more values, to generate ejection data for a first print mode used in each of the plurality of times of the scans;

a second generating step for performing a mask process in use of a mask to the binary data of each of the pixels constituting the image to be printed on the predetermined region to generate ejection data for a second print mode used in each of the plurality of times of the scans; and

a control step for changing the ejection data generation by the first generating step or by the second generating step corresponding to a form of the binary data of each of the pixels constituting the image to be printed on the predetermined region,

wherein the mask used in the second generating step assigns the binary data showing printing for each pixel to a plurality of times of scans among the plurality of times of the scans completing the printing to generate the ejection data for each scan of the pixel.

According to the present invention, for example, even if various binary image data for use in printing generated by different binarization methods of products by different RIP benders is inputted into the inkjet printing apparatus, the desired reach density and density expression in a printing image can be realized.

Further features of the present invention will become apparent from the following description of exemplary embodiments (with reference to the attached drawings).

### BRIEF DESCRIPTION OF THE DRAWINGS

FIG. 1 is a perspective view showing a schematic construction of an inkjet printing apparatus used in an embodiment according to the present invention;

FIG. 2 is an electrical block diagram showing a schematic construction of a print control circuit in the inkjet printing apparatus used in the present embodiment;

FIG. 3 is a diagram explaining a data processing flow used in a first embodiment according to the present invention;

FIG. 4 is a block diagram explaining a flow of an image data conversion process used in the present embodiment;

FIG. 5A and FIG. 5B are diagrams each explaining a data processing flow used in the first embodiment of the present invention;

FIG. 6A and FIG. 6B are diagrams each explaining a mask pattern applied to the first embodiment of the present invention;

FIG. 7 is a diagram showing a region of 4×4 areas (pixels) positioned in the upper left of a pattern printed by each nozzle group in a mask pattern of three-pass in each of the first embodiment and the second embodiment of the present invention;

FIG. 8(a) to FIG. 8(z) are diagrams each explaining a state for printing an image in the first embodiment of the present invention; and

FIG. 9 is a diagram showing the dot arrangement and the number of ink drops in the conventional method.

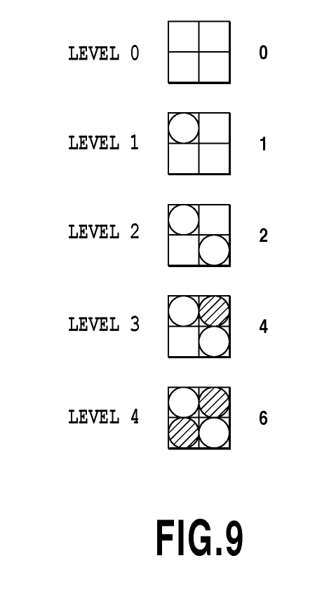

### DESCRIPTION OF THE EMBODIMENTS

### First Embodiment

Hereinafter, a first embodiment according to the present invention will be in detail explained.

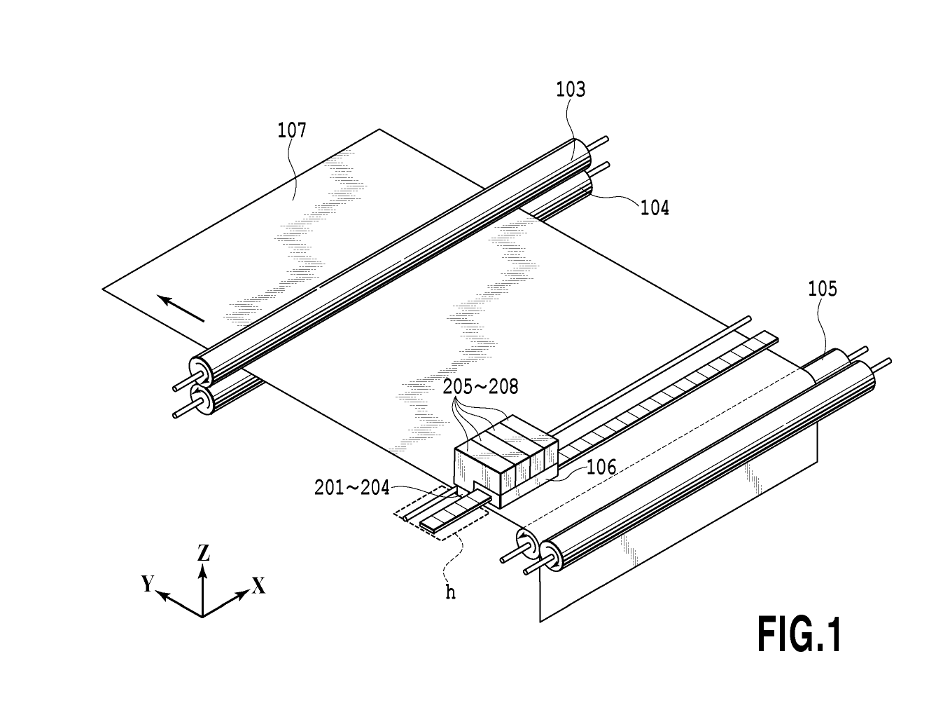

FIG. 1 shows one construction example of a color inkjet printing apparatus applicable in the present embodiment. The color inkjet printing apparatus is provided with ink tanks 205 to 208 which accommodate inks of four colors (cyan, magenta, yellow and black: C, M, Y, and K) respectively and are constructed to be capable of supplying the inks of the four colors to print heads 201 to 204. The print heads 201 to 204 are provided to correspond respectively to the inks of the four colors and eject the inks supplied from the ink tanks 205 to 208. For reducing the granular feeling of a printing image, an ink drop ejected from each of print elements arranged in the print head is set to a small ink drop of a fixed quantity.

A feed roller 103 rotates while nipping a print medium (paper sheet) 107 in conjunction with an auxiliary feed roller 104, to feed the print medium 107, and also has a function of holding the print medium 107. A carriage 106 is capable of being equipped with the ink tanks 205 to 208 and the print heads 201 to 204, and is constructed to be capable of, together with the print heads and the ink tanks, reciprocating in the X direction. The print head ejects ink during the reciprocation of the carriage 106, thereby printing an image on the print medium. In the non-print operation such as in a recovery operation of the print heads 201 to 204 or the like, the carriage 106 is controlled to wait in a home position h indicated with a dotted line in the figure.

The print heads 201 to 204 waiting in the home position shown in FIG. 1 receive a printing start instruction, thereupon ejecting ink to print an image on the print medium 107 while moving in the X direction in the figure along with the carriage 106. One move (scan) of the print head allows printing to be performed on a region having a width corresponding to an arrangement range of ejection openings of the print head 201. Upon completion of the printing associated with one scan in the main scan direction (X direction) of the carriage 106, the carriage 106 moves back to the home position h, and then performs printing by the print heads 201 to 204 while scanning in the X direction again. After the completion of the previous printing scan and before the beginning of the subsequent printing scan, the feed roller 103 rotates to feed the print medium toward the sub-scan direction (Y direction) crossing the main scan direction. The printing scan of the print head and the feeding of the print medium are repeated in this manner to complete the printing of an image on a predetermined region of the print medium 107. The printing operation of ejecting the ink from the print heads 201 to 204 is performed based on the control by control means which will be described later.

In the above example, an explanation is made of a case of performing so-called one-way direction printing in which the print head performs the printing operation only at the time the print head scans in the going direction. However, the present invention is applicable to a case of performing so-called bidirectional printing in which the print head performs the printing both at scanning time in the going direction and at scanning time in the returning direction. In addition, the above example represents the construction of mounting the ink tanks 205 to 208 and the print heads 201 to 204 on the carriage 106 to be separable. Instead, a form of mounting a cartridge incorporating the ink tanks 205 to 208 and the print heads 201 to 204 integral with each other therein on the carriage may be employed. Further, a form of mounting an integral multicolor print head capable of ejecting inks of different colors from the single print head on the carriage may be employed.

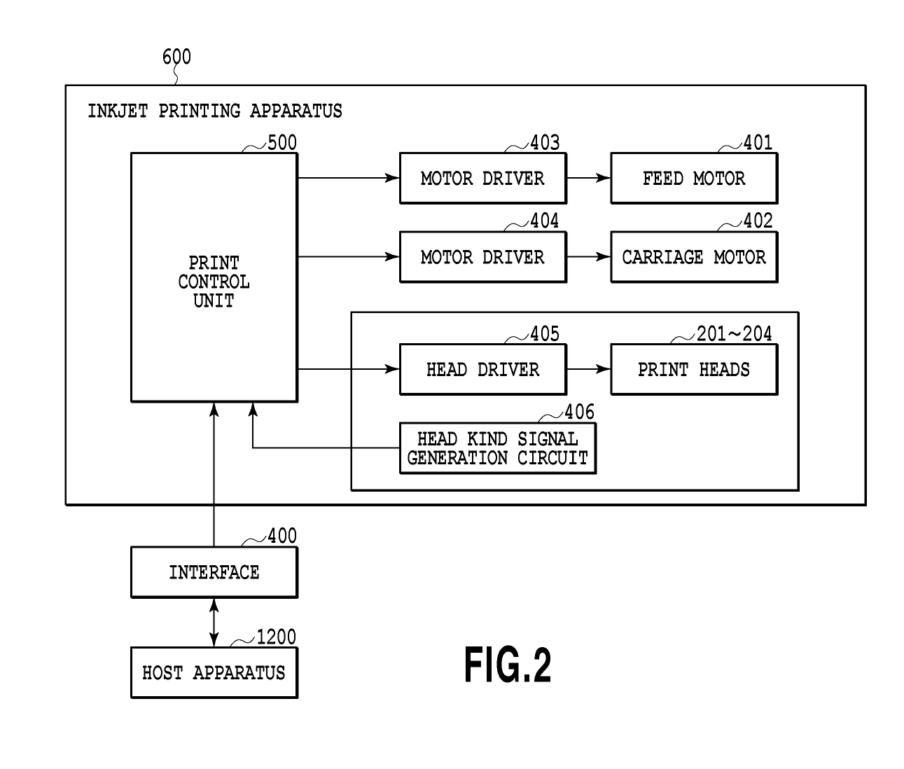

FIG. 2 is a block diagram showing a schematic construction of a print control circuit of the color inkjet printing apparatus shown in FIG. 1. The inkjet printing apparatus 600 is connected via an interface 400 to a data supply apparatus such as a host computer (hereinafter referred to as “host apparatus”) 1200 or the like. A variety of data, control signals related to printing, and the like which are transmitted from the data supply apparatus are inputted to a print control unit 500 of the inkjet printing apparatus 600. The print control unit 500 controls motor drivers 403, 404 and head drivers 405, which will be described later, in accordance with the control signals received through the interface 400. The print control unit 500 processes the received image data and a signal inputted from a head kind signal generation circuit 406 which will be described later. Reference numeral 401 denotes a feed motor for rotating the feed roller 103 to feed the print medium 107. Reference numeral 402 denotes a carriage motor for causing the carriage 106 carrying the print heads 201 to 204 to reciprocate. Reference numerals 403 and 404 denote motor drivers for respectively driving the feed motor 401 and the carriage motor 402. Reference numeral 405 denotes the head drivers for driving the print heads 201 to 204, a plurality of head drivers being provided in correspondence with the number of print heads. Reference numeral 406 denotes the head kind signal generation circuit and transmits signals representative of the kind and the number of the print heads 201 to 204 mounted on the carriage 105 to the print control unit 500.

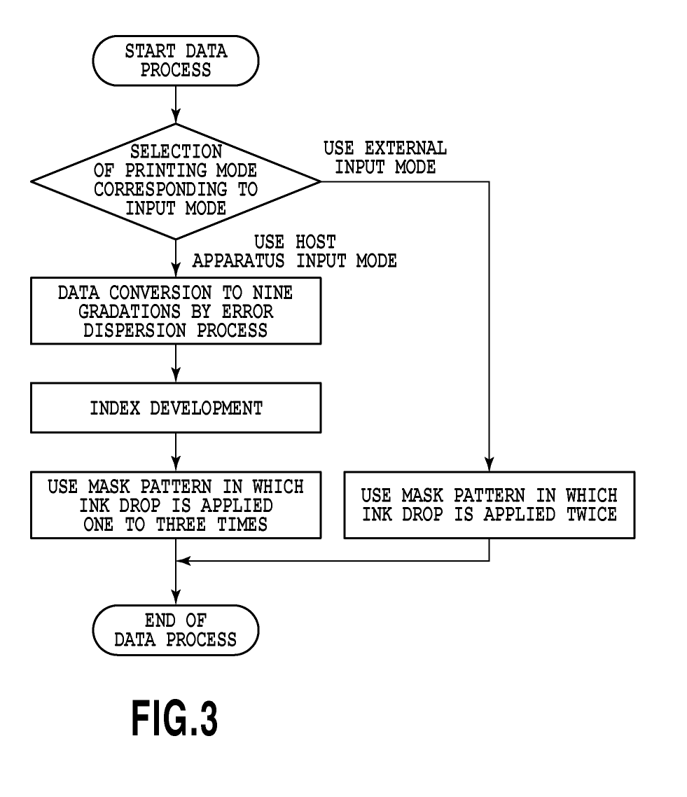

In the present embodiment, an input mode is classified into a host apparatus input mode or an external input mode depending on whether image data for use in printing inputted to the inkjet printing apparatus is data generated by the host apparatus or external data generated by the other company's RIP bender or the like. The present embodiment discloses the inkjet printing apparatus for performing the printing by a printing mode corresponding to each of the two input modes. A user can select and set the input mode for use in the host apparatus or the inkjet printing apparatus. The input mode functions to classify whether the data to be inputted is generated by the host apparatus or by the external device. In a case where the external data is not converted and is inputted via the host apparatus into the inkjet printing apparatus to be used as it is, the external input mode is used. FIG. 3 schematically shows a flow of a data process performed in the host apparatus and/or the inkjet printing apparatus in accordance with the input mode. The details will be explained for each case as follows.

### (1. Case of Host Apparatus Input Mode)

The host apparatus input mode is used in a case of inputting multi-level printing image data generated through a printer driver in the host apparatus connected to the inkjet printing apparatus into the inkjet printing apparatus. This multi-level printing image data is multi-level data as an index of a gradation level having two or more values for specifying a dot arrangement pattern.

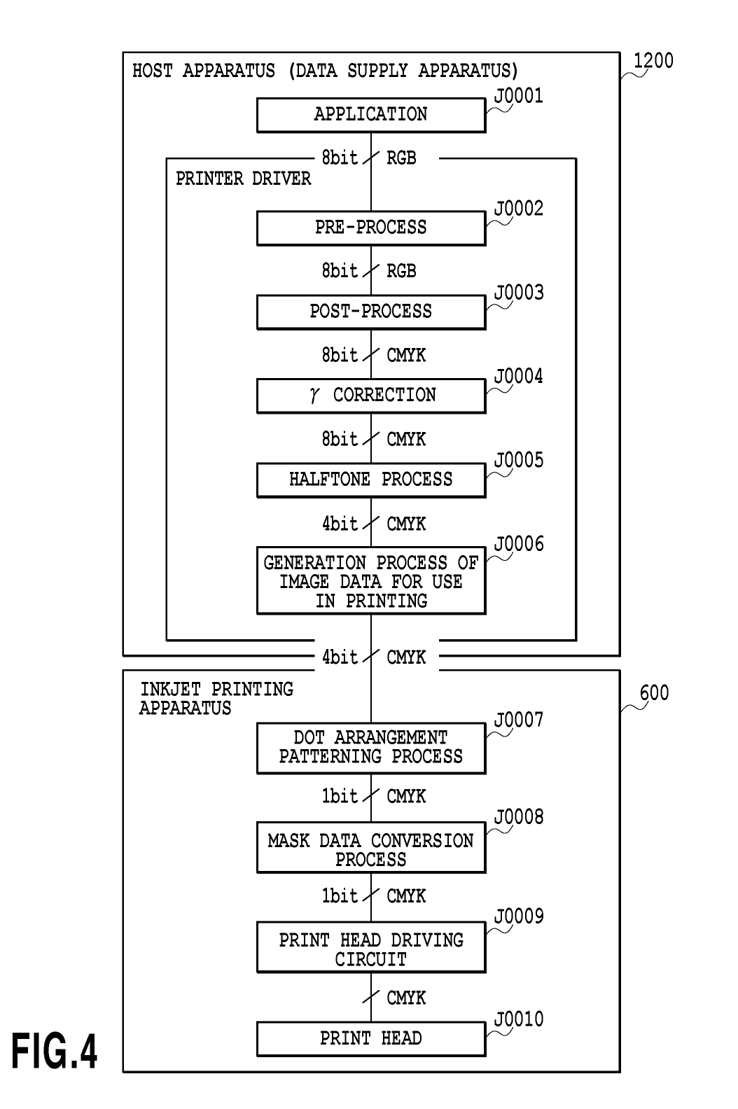

FIG. 4 is a block diagram showing a flow of an image data conversion process in the present embodiment. The inkjet printing apparatus applied in the present embodiment performs printing by using four basic colors of cyan, magenta, yellow and black, and therefore, print heads for ejecting inks of the four colors are prepared. As shown in FIG. 4, each process shown herein is designed to be constructed by the inkjet printing apparatus and a personal computer (PC) as the host apparatus.

There are provided an application J0001 and a printer driver as programs operable in an operating system of the host apparatus. The application J0001 performs a process of generating image data at a resolution of 600 ppi (pixel/inch) to be printed by the inkjet printing apparatus 600. At printing, the image data at a resolution of 600 ppi generated by the application J0001 is supplied to the printer driver.

The printer driver in the present embodiment includes a pre-process J0002, a post-process J0003, γ correction J0004, a halftone process J0005, and a printing image data generation process J0006. Here, when each process is explained briefly, mapping to a color gamut is performed in the pre-process J0002, and next, data conversion for mapping a color gamut reproduced by image data of R, G and B of an sRGB standard within the color gamut reproduced by the inkjet printing apparatus is carried out. Data in which each of R, G and B is expressed by 8 bits is converted into 8-bit data of R, G and B having a different content by using a three-dimensional lookup table (LUT) together with an interpolation calculation.

In the post-process J0003, based upon the data of R, G and B subjected to the mapping of the color gamut, a process for finding color separation data of C, M, Y and K corresponding to a combination of inks reproducing colors expressed by the above data is performed. Here, the post-process J0003 is performed together with use of the three-dimensional LUT and the interpolation calculation as similar to the pre-process J0002.

In the γ correction J0004, in regard to the color separation data found by the post-process J0003, the gradation-level conversion is performed for the data of each color. Specially, by using a primary dimensional LUT in accordance with gradation characteristics of each color ink in the inkjet printing apparatus, the conversion is carried out in such a manner that the color separation data is linearly associated with the gradation characteristics in the inkjet printing apparatus.

The above process is likewise performed for each printing color in the inkjet printing apparatus. Since the present embodiment is provided with the inkjet printing apparatus having four printing colors of C, M, Y and K, the same process is performed four times or four same processes are performed in parallel.

In the halftone process J0005, a quantization of converting 8-bit color separation data at a resolution of 600 ppi into 4-bit data is performed. The present embodiment uses an error dispersion method to convert 8-bit data of 256 gradations at a resolution of 600 ppi into 4-bit data of 9 gradations at a resolution of 600 ppi. The 4-bit data is data as a multi-gradation index for showing an arrangement pattern of dots in the dot arrangement patterning process in the inkjet printing apparatus.

The printing image data generation process J0006, as a final process performed by the printer driver in the host apparatus, generates image data for use in printing by adding printing control data to the 4-bit data at a resolution of 600 ppi including a content of the 4-bit index data. The host apparatus outputs the generated multi-level printing image data via an interface to the inkjet printing apparatus.

Next, the inkjet printing apparatus performs the dot arrangement patterning process J0007 and the mask data conversion process J0008 to the inputted multi-level printing image data to be associated with each other (by first generating means), thus performing ejection data generation.

Hereinafter, an explanation will be made of the dot arrangement patterning process J0007 to be applied in a printing mode (first printing mode) corresponding to the host apparatus input mode. In the aforementioned halftone process J0005, the level number is lowered from multi-level density information (8-bit data) of 256 gradations at a resolution of 600 ppi to gradation level information (4-bit data) of 9 gradations. On the other hand, in the present embodiment, information which the inkjet printing apparatus can print is binary information whether to print ink at a resolution of 1200 ppi. Therefore, in the present embodiment, the dot arrangement patterning process J0007 functions to reduce the multi-level of 0 to 8 at a resolution of 600 ppi to the binary level at a resolution of 1200 ppi for determining presence/absence of dot formation. Specially, in the dot arrangement patterning process J0007, to each pixel expressed by 4-bit data of level 0 to 8 at a resolution of 600 ppi as an output value from the halftone processing unit, a dot arrangement pattern corresponding to a gradation level (levels 0 to 8) of the pixel is assigned. In consequence, ON/OFF of formation of dots is defined in a region of 2×2 areas at a resolution of 1200 ppi corresponding to one pixel at a resolution of 600 ppi to perform 1-bit ejection data generation of “1” or “0” in each area.

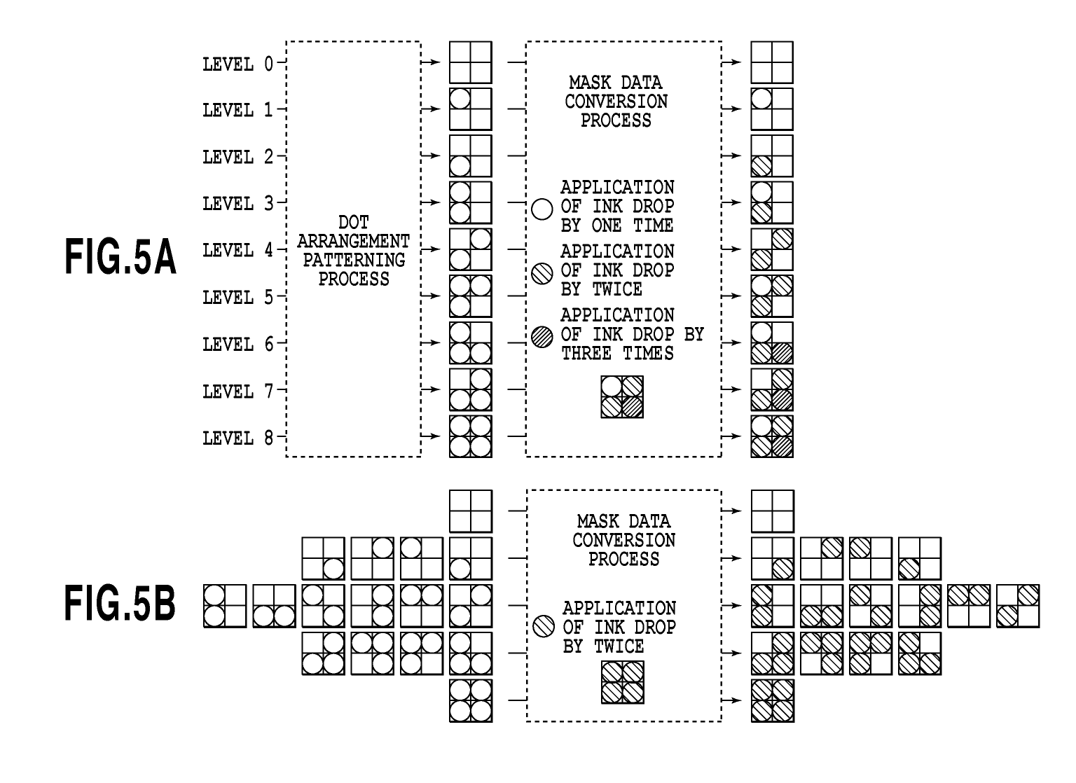

FIG. 5A shows processes performed in the dot arrangement patterning process (in FIG. 4, J0007) and the mask data conversion process (in FIG. 4, J0008). The gradation levels of 9 gradations of 4-bit at a resolution of 600 ppi generated by the printing image data generation process (in FIG. 4, J0006) are defined as level 0 to level 8. In the dot arrangement patterning process (in FIG. 4, J0007), a dot arrangement pattern at a resolution of 1200 ppi corresponding to the gradation level (0 to 8) of the pixel is assigned. According to the data in a stage where this process is completed, the number of areas in which the dot formation is ON is two equally between level 3 and level 4, which corresponds to the gradation expressing the same printing density. In this manner, in a stage where this process is completed, the number of the areas in which the dot can be formed is in a range of 0 to 4, and a total gradation number is 5.

Next, the mask data conversion process (in FIG. 4, J0008) (so-called mask process) is performed to the data obtained by the dot arrangement patterning process (in FIG. 4, J0007). Herein, in the present embodiment, multi-pass printing of 3-pass is designed to be performed. It should be noted that the pass number of the multi-pass is only required to be set in such a manner that, as a result of a plurality of scans by the print head, the target number of ink drops can be applied to each area, and is not limited thereto.

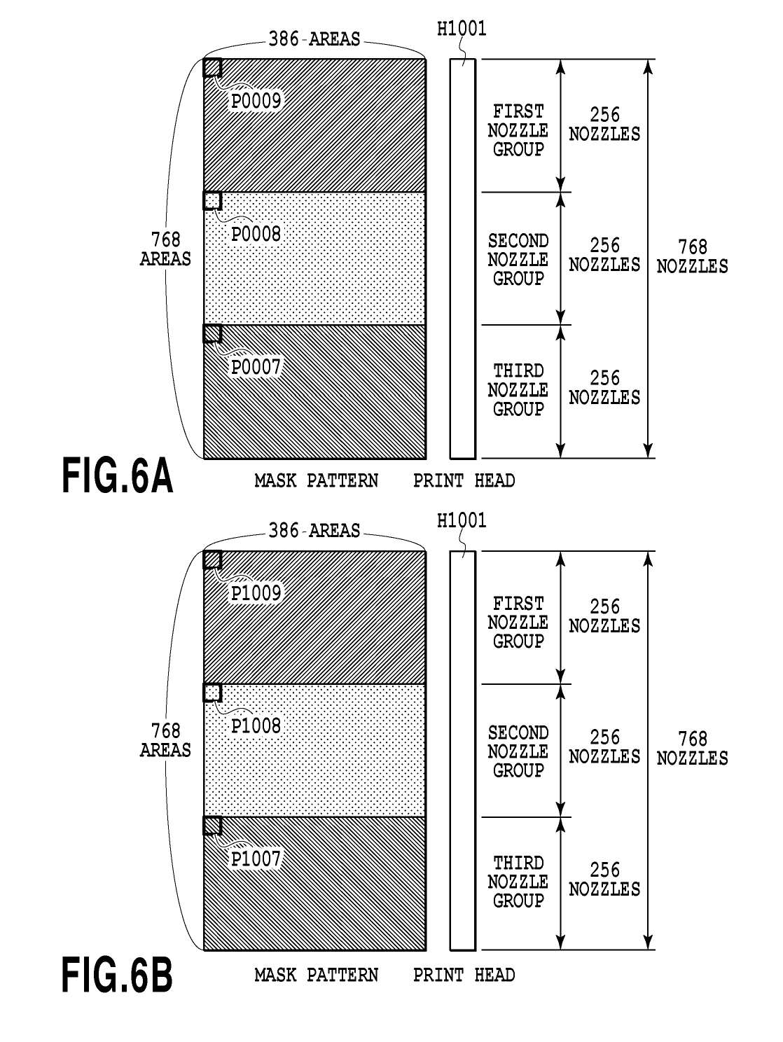

FIG. 6A shows a mask pattern applied in a printing mode (that is, for the first printing mode) corresponding to the host apparatus input mode. A print head H1001 applied in the present embodiment has 768 pieces of nozzles and herein multi-pass printing of 3-pass is performed. Therefore, 768 pieces of the nozzles are divided into three nozzle groups each having 256 pieces of the nozzles. A size of the mask pattern is divided into 768 areas equivalent to the nozzle number in the vertical direction and 386 areas in the lateral direction. In the present embodiment, ejections of inks from the three nozzle groups are overlapped with each other in printing, and ink drops of 0 to 8, that is, 8 ink drops at a maximum are applied to one pixel at a resolution of 600 ppi.

Hereinafter, an object and a construction of an application of the ink drops of 8 pieces at a maximum to one pixel at a resolution of 600 ppi will be in detail explained. When the dot arrangement patterning process shown in FIG. 5A is performed to the data obtained by the halftone process (in FIG. 4, J0005), ink drops of 4 pieces at a maximum are applied to a region expressed by one pixel at a resolution of 600 ppi. In the inkjet printing apparatus of the present embodiment, the print head is constructed such that an ink drop having a small ejection quantity is ejected for improving an image quality of a high image quality printing mode. Specially, an image is designed such that ink drops are applied to one pixel at a resolution of 600 ppi until 8 pieces at a maximum. That is, when printing is performed in a setting state in which ink drops are applied to one pixel at a resolution of 600 ppi until four pieces, an ink quantity ejected to one pixel at a resolution of 600 ppi becomes insufficient, as a result generating only an image having an insufficient printing density. In the printing mode corresponding to the host apparatus input mode, the lack of the ink quantity is compensated by the mask data conversion process (in FIG. 4, J0008).

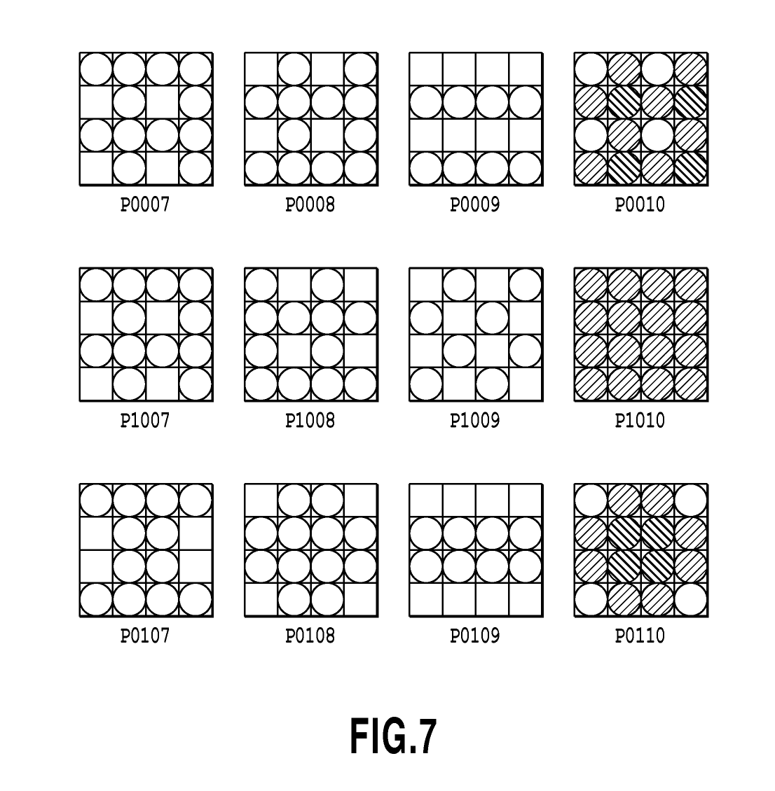

P0007 to P0009 in FIG. 7 are shown by enlarging regions P0007 to P0009 each having 4×4 areas at a resolution of 1200 ppi positioned in the upper left in a region corresponding to each nozzle group in the mask pattern in FIG. 6A. These three regions are overlapped on a print medium to be printed, and P0010 shows a result of overlapping patterns P0007 to P0009. In P0007 to P0009, a portion shown in a white circle shows an area for printing by applying an ink drop with the printing scan to form a dot. In P0010, a portion shown in a white circle shows an area on which an ink drop is applied one time (by one piece). Likewise, a portion shown in a white circle where inclined lines are drawn from the upper right to the lower left shows an area on which ink drops are applied twice (by two pieces), and a portion shown in a white circle where inclined lines are drawn from the upper left to the lower right shows an area on which ink drops are applied three times (by three pieces). As seen in P0010, the number of application times (the number of application pieces) of the ink drops are repeated with keeping regularity at a minimum unit of 2×2 areas at a resolution of 1200 ppi, and 8 pieces of the ink drops at a maximum are applied to one pixel at a resolution of 600 ppi.

By referring again to FIG. 5A, as described above, in a stage where the dot arrangement patterning process (in FIG. 4, J0007) is completed, data of five gradations in which four dots at a maximum are formed to one pixel at a resolution of 600 ppi by four ink drops at a maximum is generated. In the printing mode corresponding to the host apparatus input mode in the present embodiment, the mask data conversion process (in FIG. 4, J0008) is performed in addition to the dot arrangement patterning process (in FIG. 4, J0007). By associating these processes to perform the process according to a given rule, 8 pieces of the ink drops at a maximum are applied to one pixel at a resolution of 600 ppi generated by the halftone process (in FIG. 4, J0005), thereby making it possible to express nine gradations. The present embodiment can avoid lack of the ink quantity to one pixel by the above construction, and a desired reach printing density can be realized without slowing down the printing speed. In addition, since the nine gradations can be expressed, a fine density expression can be carried out in the printing image.

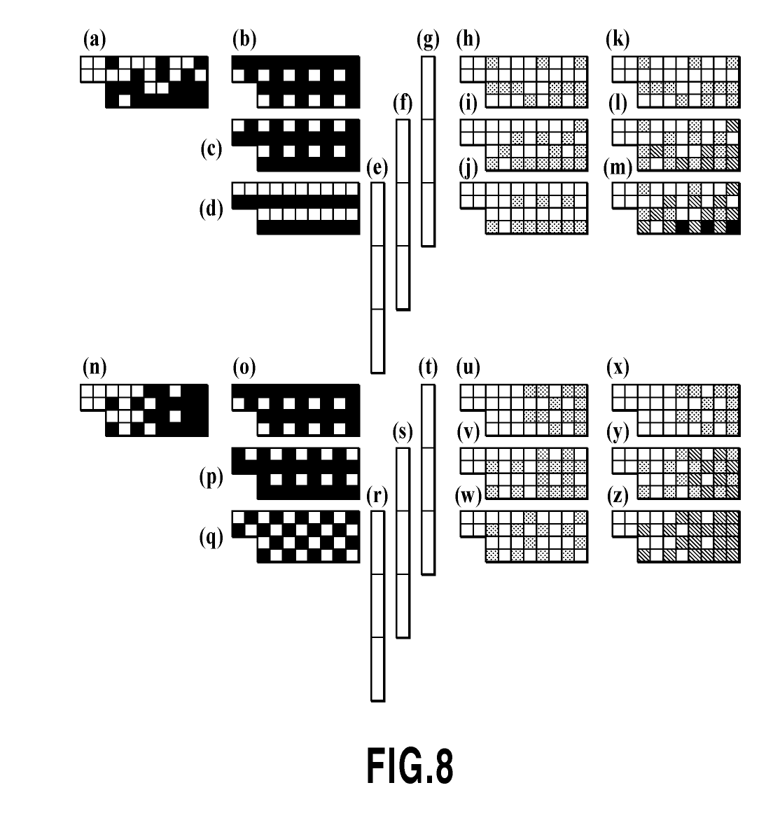

The above content will be explained by being associated with a print head scan in the inkjet printing apparatus with reference to FIG. 8 (a) to FIG. 8 (m).

FIG. 8 (a) shows image data of a binary level at a resolution of 1200 ppi obtained by performing the dot arrangement patterning process (in FIG. 4, J0007) to image data for use in printing generated by the printer drive in the host apparatus and inputted into the inkjet printing apparatus. FIG. 8 (b) to FIG. 8 (d) are the mask pattern shown in FIG. 6 A. As shown in each of FIG. 8 (e) to FIG. 8 (g), the print head is divided into three regions in the nozzle row direction. At this time, FIG. 8 (b) shows a mask pattern used in one of the three regions of the print head in the upper side of the figure, FIG. 8 (c) shows a mask pattern used in one of the three regions of the print head in the center of the figure, and FIG. 8 (d) shows a mask pattern used in one of the three regions of the print head in the lower side of the figure. Ejection data shown in FIG. 8 (h) to FIG. 8 (j) can be obtained by AND of FIG. 8 (a) and FIG. 8 (b) to FIG. 8 (d). When FIG. 8 (h) and FIG. 8 (i) overlap, the ejection data becomes as shown in FIG. 8 (l), and when FIG. 8 (j) further overlaps thereon, the ejection data becomes as shown in FIG. 8 (m). The print medium is fed in the feeding direction (in FIG. 1, Y direction) during the time between a plurality of printing scans of the print head in the main scan direction (in FIG. 1, X direction). At this time, the print head moves relatively to the print medium in the direction of FIG. 8 (e)→FIG. 8 (f)→FIG. 8 (g).

In FIG. 8 (h) to FIG. 8 (m), a region in a black dot shows an area on which an ink drop is applied one time (one piece), a region in an inclined line shows an area on which an ink drop is applied twice (two pieces) and a region filled in black shows an area on which an ink drop is applied three times (three pieces). FIG. 8 (a) is a diagram in which the dot arrangement patterns each having 2×2 areas shown in level 0 to 8 are arranged in order. In FIG. 8 (m) also, it is understood that the number of dots formed by applying ink drops increases in a unit of a region of 2×2 areas corresponding to this pattern. One region of the 2×2 areas constitutes one pixel at a resolution of 600 ppi and an image is constructed by arranging a plurality of the pixels.

In the present embodiment, a plurality of mask data corresponding to the printing mode including the mask data shown in FIG. 6A is stored in a memory in the inkjet printing apparatus body. In the mask data conversion process, an AND process is performed between the mask data and an output signal of the aforementioned dot arrangement patterning process to determine a printing pixel for ejecting ink by each printing scan. 1-bit data of each color determined in this manner is inputted into a driving circuit (in FIG. 4, J0009) of the print head H1001 as an output signal.

The 1-bit data of each color inputted into the print head driving circuit (in FIG. 4, J0009) is converted into a drive pulse of the print head (in FIG. 4, J0010) and ink is ejected in a predetermined timing corresponding to a printing resolution of 1200 ppi by each print head.

It should be noted that the dot arrangement patterning process and the mask data conversion process in the inkjet printing apparatus are performed under control of the CPU constituting the control unit in the inkjet printing apparatus by using the respective exclusive hardware circuits.

### (2. Case of External Input Mode)

An external input mode is used in a case of inputting binary image data for use in printing shown as a dot arrangement pattern into the inkjet printing apparatus. The printing image data can be data which is subjected to a halftone process, for example, by an external RIP, which is converted into a bit map image of 1-bit at a resolution of 1200 ppi. Without mentioning, the binary data to be inputted may include binary data in advance converted using an index pattern by the RIP. In the present embodiment, the binary printing image data shown as the dot arrangement pattern in the external input mode is integration of a plurality of data formed by cutting out data in the form of bit map image to a size of a resolution of 1200 ppi.

The binary printing image data shown as the dot arrangement pattern in the external input mode is inputted into the inkjet printing apparatus, which is thereon received by the mask data conversion processing (in FIG. 4, J0008) unit. Here, the dot arrangement patterning process (in FIG. 4, J0007) unit exists within the inkjet printing apparatus, but the binary printing image data shown as the dot arrangement pattern in the external input mode bypasses the dot arrangement patterning process and is not subjected thereto. In this manner, in the external input mode, the mask data conversion process is performed (by the second generation means) without performing the dot arrangement patterning process to the binary printing image data inputted without being subjected to the conversion by the host apparatus to generate ejection data.

Information which the inkjet printing apparatus receives in a printing mode (second printing mode) corresponding to the external input mode is binary information on whether to print 1-bit ink at a resolution of 1200 ppi. As described above, the print head is constructed in such a manner as to eject ink drops having a small ejection quantity, and, for obtaining a sufficient printing density in the present embodiment, an application of ink drops equivalent to 8 pieces at a maximum is required to one pixel at a resolution of 600 ppi.

FIG. 6B shows a mask pattern applied in a printing mode (that is, for the second printing mode) corresponding to the external input mode. The print head H1001 applied in the present embodiment has 768 pieces of nozzles. Since multi-pass printing of 3-pass is herein performed, 768 pieces of the nozzles are divided into three nozzle groups each having 256 pieces of the nozzles. The mask pattern is sized to have 768 areas equivalent to the nozzle number in the vertical direction and 386 areas in the lateral direction. In the present embodiment, ejections of inks from the three nozzle groups are overlapped with each other in printing, and two ink drops at a maximum (equivalent to 8 ink drops at a maximum to one pixel at a resolution of 600 ppi) are applied to one pixel at a resolution of 1200 ppi.

P1007 to P1009 in FIG. 7 are shown by enlarging regions P1007 to P1009 each having 4×4 pixels at a resolution of 1200 ppi positioned in the upper left in a region corresponding to each nozzle group in the mask pattern in FIG. 6B. These three regions are overlapped on a print medium to be printed, and P1010 shows a result of overlapping patterns P1007 to P1009. In P1007 to P1009, a portion shown in a white circle shows a pixel for printing by applying an ink drop with the printing scan to form a dot. In P1010, a portion shown in a white circle where inclined lines are drawn from the upper right to the lower left shows a pixel on which ink drops are applied twice (by two pieces). As seen in P1007 to P1010, the number of application times (the number of application pieces) of the ink drops is repeated with keeping regularity at a minimum unit of 2×2 pixels. Therefore, the ink drop results in being applied until ink drops of two pieces (twice) at a maximum (equivalent to 8 pieces of the ink drops at a maximum to one pixel at a resolution of 600 ppi) are applied to one pixel at a resolution of 1200 ppi.

By referring to FIG. 5B, the data to be inputted in the external input mode is binary data on whether to form a dot by ejecting ink to one pixel at a resolution of 1200 ppi. For example, the region of 2×2 areas in the figure shows a region of 2×2 pixels formed by cutting out a part of the binary data to be inputted. A configuration is exemplified in which a dot is applied on the pixel in the lower left in the second region from the upper side, which shows an example of applying one dot to 2×2 pixels. The pattern in which one dot is applied is not limited thereto, but it is also exemplified that this example includes a case of applying one dot on the pixel in any of the upper left, the upper right and the lower right. Likewise, one dot is applied on each pixel in the lower left and the upper right in the third region of 2×2 pixels from the upper side, but the pattern in which two dots are is applied is not limited thereto, but this example includes a combination of cases of applying one dot on each pixel in the lower left and the upper left, in the upper left and the lower right, and in the upper right and the lower right. Likewise, an example shown in the fourth region from the upper side in the figure is an example representative of a pattern in which three dots are applied in a region of 2×2 pixels.

In the present embodiment, the dot arrangement patterning process (in FIG. 4, J0007) is not performed, but the mask data conversion process (in FIG. 4, J0008) is performed to the data inputted to the inkjet printing apparatus in the external input mode. The mask data conversion process (in FIG. 4, J0008) is associated with the inputted printing image data and performs the process according to a given rule. Therefore, by applying ink drops twice (two pieces) or zero times (zero pieces) to one pixel at a resolution of 1200 ppi, ejection data in which two dots or zero dots are formed can be obtained. This ejection data corresponds to ejection data which can express a printing density of five gradations to one pixel of at a resolution of 600 ppi.

In this manner, in the printing mode (second printing mode) corresponding to the external input mode, there is no change in the gradation level at a resolution of 600 ppi which data can express across the mask data conversion process, that is, five gradations as the same level, but an ink quantity used for expressing each gradation differs across it. That is, in the ejection data after the mask data conversion process is performed, ink drops are set to be applied twice as much as before the mask data conversion process in all the gradations to which the ink drop should be applied. Therefore, after the mask data conversion process is performed, ink drops equivalent to 8 pieces are applied to one pixel at a resolution of 600 ppi in a case where the gradation level is the maximal five. This ink drop application number is the application number of the ink drops per one pixel at a resolution of 600 ppi in the same with a case of the maximum gradation level 9 of the ejection data in the printing mode (first printing mode) corresponding to the aforementioned host apparatus input mode. Therefore, it is understood that in the first and second printing modes corresponding to both of the input modes, a desired similar reach printing density can be realized.

In the ejection data in the printing mode corresponding to the external input mode, the number of application pieces (number of application times) of ink drops applied to one pixel at a resolution of 1200 ppi when the dot formation is ON is set as two pieces (twice) and has no variation, such as one piece or two pieces (one time or twice). Therefore, it is possible to prevent the phenomenon in the conventional invention that the mask interferes with the binary data to generate moiré in the printing image, thus degrading the image quality, and an influence on the density expression in the printing image can be reduced. According to the above construction in the present embodiment, a desired reach printing density and a desired printing density expression can be realized.

The above content will be explained by being associated with a print head scan in the inkjet printing apparatus with reference to FIG. 8 (n) to FIG. 8 (z).

FIG. 8 (n) shows binary data outputted from the external RIP (Raster Image Processor). FIG. 8 (o) to FIG. 8 (q) are the mask pattern shown in FIG. 6B. As shown in each of FIG. 8 (r) to FIG. 8 (t), the print head is divided into three regions in the nozzle row direction. At this time, FIG. 8 (o) shows a mask pattern used in one of the three regions of the print head in the upper side of the figure, FIG. 8 (p) shows a mask pattern used in one of the three regions of the print head in the center of the figure, and FIG. 8 (q) shows a mask pattern used in one of the three regions of the print head in the lower side of the figure. Ejection data shown in FIG. 8 (u) to FIG. 8 (w) can be obtained by AND of FIG. 8 (n) and FIG. 8 (o) to FIG. 8 (q). When FIG. 8 (u) and FIG. 8 (v) overlap, the ejection data becomes as shown in FIG. 8 (y), and when FIG. 8 (w) further overlaps thereon, the ejection data becomes as shown in FIG. 8 (z).

The print medium is fed in the feeding direction (in FIG. 1, Y direction) during the time between a plurality of printing scans of the print head in the main scan direction (in FIG. 1, X direction). At this time, the print head moves relatively to the print medium in the direction of FIG. 8 (r)→FIG. 8 (s)→FIG. 8 (t).

In FIG. 8 (u) to FIG. 8 (z), a region in a black dot shows a pixel on which an ink drop is applied one time (one piece), a region in inclined lines shows a pixel on which an ink drop is applied twice (two pieces). FIG. 8 (n) is a diagram in which the dot arrangement patterns each having 2×2 pixels shown in FIG. 5B are arranged in order. In FIG. 8 (z) also, it is understood that the number of dots formed by applying ink drops increases in a unit of a region of 2×2 pixels corresponding to this pattern.

As described above, an explanation has been made of the printing methods by the printing modes corresponding to the two input modes in the present embodiment. That is, in a case where the input data to the inkjet printing apparatus is the printing image data of two or more levels formed by the host apparatus, the printing mode generating ejection data in which ink drops of zero to three pieces are applied per one area at a resolution of 1200 ppi is used. In addition, in a case where the input data to the inkjet printing apparatus is binary printing image data formed by the external device, the printing mode generating ejection data in which ink drops of two or zero pieces are applied per one area at a resolution of 1200 ppi is used. In this manner, by selecting the printing mode corresponding to the kind of the input data, a degree of freedom in design of independent binarization can be ensured and also a desired reach printing density can be guaranteed.

The above embodiment adopts the construction where an application of ink drops equivalent to 8 pieces at a maximum is made to one pixel at a resolution of 600 ppi. In the present invention, the resolution of the image and the number of application pieces of ink drops depend on a desired printing density or the like, and are not limited thereto.

It should be noted that the changing of the input mode can be automatically determined by the form of the input data (binary data or multi-level data). In addition, the automatic determination may be made by adding a command indicating that the data is inputted from the host apparatus (printer driver) to the inkjet printing apparatus, to the image data.

### Second Embodiment

The present embodiment changes the regularity in change of the printing pattern in the printing method corresponding to the input data for the multi-level image printing in the above first embodiment. Specially in a state where a relativity between the dot arrangement patterning process (in FIG. 4, J0007) and the mask data conversion process (in FIG. 4, J0008) is maintained, 2×2 areas as the minimum unit of the printing pattern is rotated depending on the printing position for use.

P0107 to P0109 in FIG. 7 are shown by enlarging regions each having 4×4 areas positioned in the upper left in a region corresponding to each nozzle group in the mask pattern for three-pass as similar to the first embodiment (refer to FIG. 6A) (not shown). These three regions are overlapped on a print medium to be printed, and P0110 shows a result of overlapping patterns P0107 to P0109. In P0107 to P0109, a portion shown in a white circle shows an area for printing by applying an ink drop with the printing scan to form a dot. In P0110, a portion shown in a white circle shows an area on which an ink drop is applied one time (by one piece). Likewise, a portion shown in a white circle where inclined lines are drawn from the upper right to the lower left shows an area on which ink drops are applied twice (by two pieces), and a portion shown in a white circle where inclined lines are drawn from the upper left to the lower right shows an area on which ink drops are applied three times (by three pieces).

As seen in P0107 to P0109, each printing pattern is formed by regularly rotating and repeating a minimum unit of 2×2 areas at a resolution of 1200 ppi constituting one pixel at a resolution of 600 ppi. Therefore, 8 pieces of the ink drops at a maximum are applied to one pixel at a resolution of 600 ppi.

In this manner, one of embodiments in the present invention for alleviating an influence of regularity in the printing pattern on the printing density expression by the binarization method of the input data to improve an image quality may use a pattern for rotating 2×2 areas of a minimum unit as in the case of the present embodiment. The present embodiment selects 4×4 areas twice as large as 2×2 areas of the minimum unit as a repetition unit in the printing pattern, but is not limited thereto.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-016783, filed Jan. 28, 2011, which is hereby incorporated by reference herein in its entirety.

What is claimed is:

1. An inkjet printing apparatus which performs a plurality of times of scans by a print head on a predetermined region and completes printing of the predetermined region by ejecting ink from the print head by the plurality of times of the scans, comprising:
generating means for performing a mask process in use of a mask to binary data of each of pixels constituting an image to be printed on the predetermined region to generate ejection data used in each of the plurality of times of the scans,
wherein the mask assigns the binary data showing printing for each pixel to a plurality of times of scans among the plurality of times of the scans completing the printing to generate the ejection data for each scan of the pixel.

2. An inkjet printing apparatus which performs a plurality of times of scans by a print head on a predetermined region and performs printing by ejecting ink from the print head by the plurality of times of the scans, comprising:
first generating means for performing a mask process in use of a mask to binary data of each of pixels constituting an image to be printed on the predetermined region, which are obtained according to a dot arrangement pattern specified by multi-level data having a gradation level of two or more values, to generate ejection data for a first print mode used in each of the plurality of times of the scans;
second generating means for performing a mask process in use of a mask to the binary data of each of the pixels constituting the image to be printed on the predetermined region to generate ejection data for a second print mode used in each of the plurality of times of the scans; and
control means for changing the ejection data generation by the first generating means or by the second generating means corresponding to a form of the binary data of each of the pixels constituting the image to be printed on the predetermined region,
wherein the mask used in the second generating means assigns the binary data showing printing for each pixel to a plurality of times of scans among the plurality of times of the scans completing the printing to generate the ejection data for each scan of the pixel.

3. An inkjet printing apparatus according to claim 2, wherein the number of application pieces of ink drops per one pixel in a printing density expressing the maximum gradation is equal between the ejection data for the first printing mode and the ejection data for the second printing mode.

4. An inkjet printing method by an inkjet printing apparatus which performs a plurality of times of scans by a print head on a predetermined region and completes printing of the predetermined region by ejecting ink from the print head by the plurality of times of the scans, comprising:
a generating step for performing a mask process in use of a mask to binary data of each of pixels constituting an image to be printed on the predetermined region to generate ejection data used in each of the plurality of times of the scans,
wherein the mask assigns the binary data showing printing for each pixel to a plurality of times of scans among the plurality of times of the scans completing the printing to generate the ejection data for each scan of the pixel.

5. An inkjet printing method by an inkjet printing apparatus which performs a plurality of times of scans by a print head on a predetermined region and performs printing by ejecting ink from the print head by the plurality of times of the scans, comprising:
a first generating step for performing a mask process in use of a mask to binary data of each of pixels constituting an image to be printed on the predetermined region, which are obtained according to a dot arrangement pattern specified by multi-level data having a gradation level of two or more values, to generate ejection data for a first print mode used in each of the plurality of times of the scans;
a second generating step for performing a mask process in use of a mask to the binary data of each of the pixels constituting the image to be printed on the predetermined region to generate ejection data for a second print mode used in each of the plurality of times of the scans; and
a control step for changing the ejection data generation by the first generating step or by the second generating step corresponding to a form of the binary data of each of the pixels constituting the image to be printed on the predetermined region,
wherein the mask used in the second generating step assigns the binary data showing printing for each pixel to a plurality of times of scans among the plurality of times of the scans completing the printing to generate the ejection data for each scan of the pixel.
